(19) United States
(12) Patent Application Publication
(10) Pub. No.: US 2026/0296278 A1
(43) Pub. Date: Oct. 1, 2026

(54) FIBER-WOUND SEAT

(71) Applicant: LEAR CORPORATION, Southfield, MI (US)

(72) Inventors: Jonathan Papa, Royal Oak, MI (US); Caleb A. Abbey, Warren, MI (US); Louella Patterson, Goodells, MI (US); Michael Powell, Waterford, MI (US); Jeanette Puig-Pey Stiefel, Bloomfield Hills, MI (US); Paul S. Severinski, Brownstown, MI (US); Mark S. Weaver, Auburn Hills, MI (US); Katherine Champion, Berkley, MI (US); Stanley J. Marek, Farmington Hills, MI (US); Sajad Arabnejad, Ann Arbor, MI (US)

(21) Appl. No.: 19/092,396

(22) Filed: Mar. 27, 2025

(51) Int. Cl. B60N 2/68; B60N 2/22

(52) U.S. Cl. CPC B60N 2/682; B60N 2/22

(57) ABSTRACT

A seat system includes a seat frame that has a plurality of nodes and at least one resin-impregnated fiber bundle that is wound around the nodes. A cushion material is secured to couplings on the nodes of the seat frame.

### BACKGROUND

A seat in an automobile or other vehicle typically includes a chassis and/or frame on which seat cushions and other components of the seat are mounted. The chassis or frame also provides strength and stiffness to support the seat occupant.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a seat system.

FIG. 2A illustrates a bobbin style node of the seat system.

FIG. 2B illustrates a low-profile bobbin node.

FIG. 3 illustrates a portion of seat from of the seat system.

FIG. 4 illustrates a cushion attached with the nodes.

FIG. 5 illustrates a seat frame that has nodes and bar linkages interconnecting the nodes.

FIG. 6 illustrates the nodes and bar linkages with a socket joint.

FIG. 7 illustrates an integrated ring bar linkage.

FIG. 8 illustrates a folded substrate that has nodes.

FIG. 9 illustrates the substrate in an unfolded state.

FIG. 10 illustrates the substrate with a backing plate and cushion.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

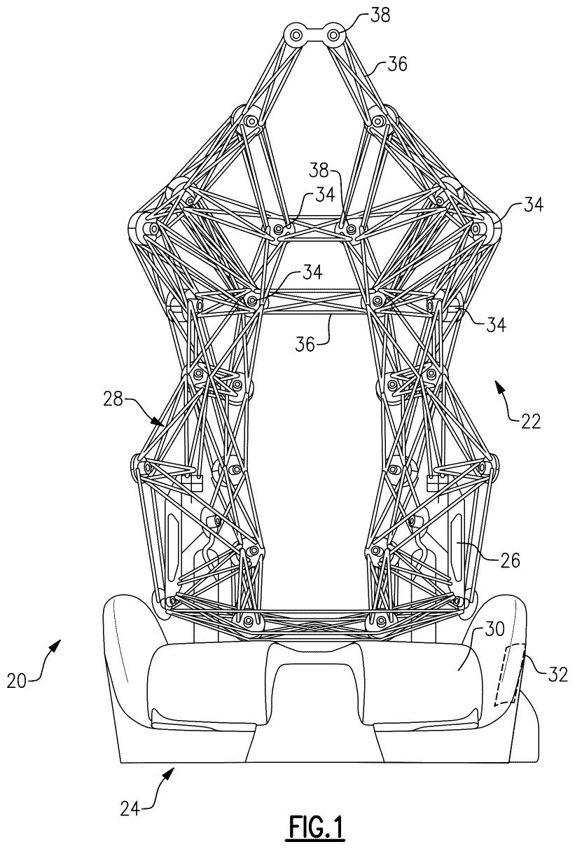

FIG. 1 illustrates portions of an example seat system 20 for an automobile. In this example, the seat system 20 system includes a seat back 22 and a seat base 24. A seat chassis 26 supports a seat frame 28 mounted thereon. Cushions 30 are mounted on the seat base 24 and frame 28, although the cushions on the frame 28 are excluded in order to view the frame 28. There is a reclining mechanism 32 between the seat base 24 and the seat back 22 that permits the seat back 22 to pivot relative to the seat base 22. As will be appreciated, the seat system 20 may additionally include other features that are not shown in the illustrated example, such as but not limited to, massaging bladders, a cooling system, and a heating system. Although the example seat system 20 is for an automobile, it is to be understood that the examples are applicable to other types of vehicles, such as but not limited to, a motorcycle, a watercraft, an aircraft, or a locomotive.

The frames of known seat systems may be made from metal alloys. While strong and durable, metal alloys are often heavy and can be expensive. Therefore, performance benefits afforded by metal seat frames come with a weight penalty. As discussed herein, the example seat systems include seat frames that are of light-weight construction, yet provide good strength and stiffness that is desired in seating, especially high performance seats that are intended to tightly hold the occupant during aggressive vehicle maneuvering. In this regard, the example seat frames herein are made from a lightweight fiber-reinforced material.

The seat frame 28 includes a plurality of nodes 34 and at least one resin-impregnated fiber bundle 36 that is wound around the nodes 34. For example, the fiber bundles are carbon fiber yarn, but alternatively may be another type of high-strength fiber. The nodes 34, in general, are structures around which the fiber bundle wraps to change direction and form the shape of the frame 28. The nodes 34 may be formed from molded plastic and include couplings 38 for attaching one or more of the cushions 30. The coupling may include threaded and/or untrhreaded features for attachment. For instance, a coupling is a mechanical feature that serves to join two parts together, such as a connector that mates with a corresponding connector on the cushion 30. One example of a coupling 38 is a snap or a friction-fit. Another example is a screw into a threaded or unthreaded hole.

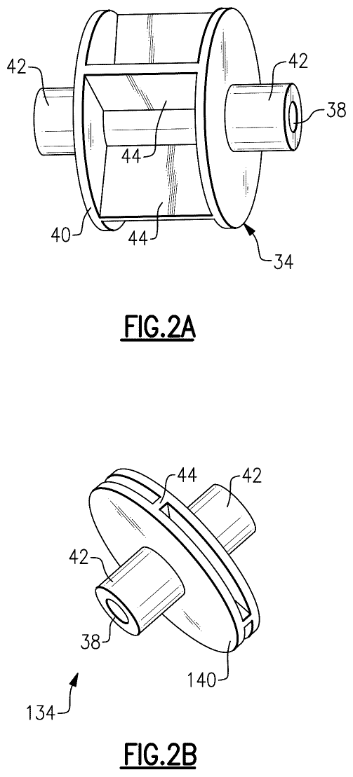

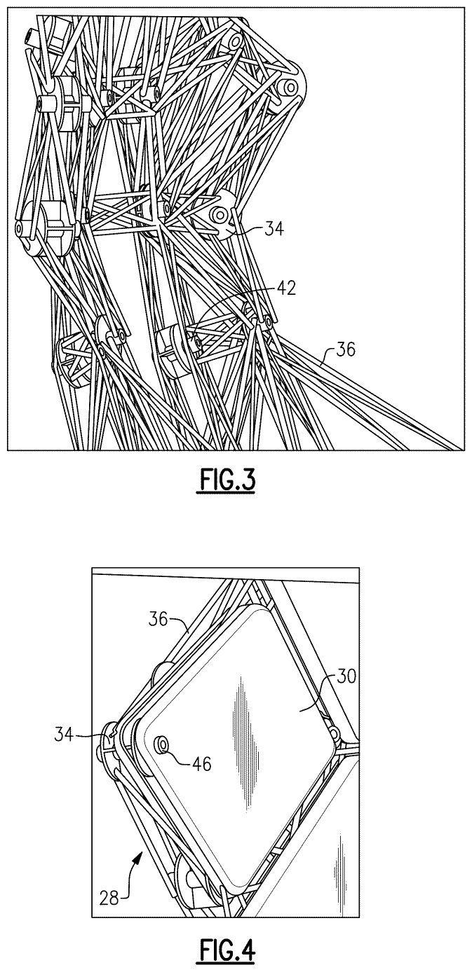

FIG. 2A illustrates an example of one of the nodes 34, which is a “bobbin” style of node. The node 34 includes a cylindrical body 40 sized to contain fiber buildup and spindle portions 42 that extend axially from each end of the body 40. The couplings 38 are formed in the ends of the spindle portions 42 and may be threaded and/or unthreaded. The body 40 includes ribs 44 to add strength and stiffness. FIG. 2B illustrates another example node 134. The node 134 is similar to the node 34 except that it has a low-profile body 140 that is axially shorter than the body 40. For instance, the axial height of the body 140 is substantially less than the diameter of the body 140.

As shown in FIG. 3, the fiber bundle 36 is wrapped around the nodes 34. In particular, the fiber bundle 36 wraps around the spindle portions 42. As an example, the fiber bundle 36 may wrap a full turn of 360° or multiple full turns around an individual spindle portion 42, may wrap less than a full turn around an individual spindle portion 42, or may wrap a full turn or more around some individual spindle portions 42 and less than full around other individual spindle portions 42. Additionally, in the example shown, the fiber bundle 36 is a single fiber bundle 36 that continuously wraps around all of the nodes 34. Use of a single fiber bundle 36 may facilitate enhancement of strength and stiffness. Alternatively, multiple fiber bundles 36 may be used. The fiber bundle 36 may be doubled-up (or more) between two or more of the nodes 34, for added strength and stiffness. For instance, between two or more nodes 34, there is from 2 to 10 “strands” of the fiber bundle 36.

In one example of the manufacture of the frame 28, a fiber preform is made by mounting the nodes 34 on a tool in a desired configuration. The fiber bundle 36 is then wrapped around the nodes 34 a desired number of times to achieve a target strength and stiffness. The wrapping may be performed manually or in an automated manner. Automation may provide faster processing and control over tension on the fiber bundle 36. The fiber bundle 36 is resin-impregnated with a polymeric material, such as with but not limited to epoxy. After the wrapping, the resulting fiber preform is then heat treated in order to cure the resin. The heat treating may be performed while the preform is still on the tool in order to maintain the shape of the preform prior to the curing and to resist thermal warping during curing. Upon cooling, the frame is then removed from the tool. In subsequent steps, the cushions 30 are mounted to the couplings 38 on the nodes 34. For instance, as shown in FIG. 4, the cushions 30 have mating couplings 46 that attach to the couplings 38 of the frame 28.

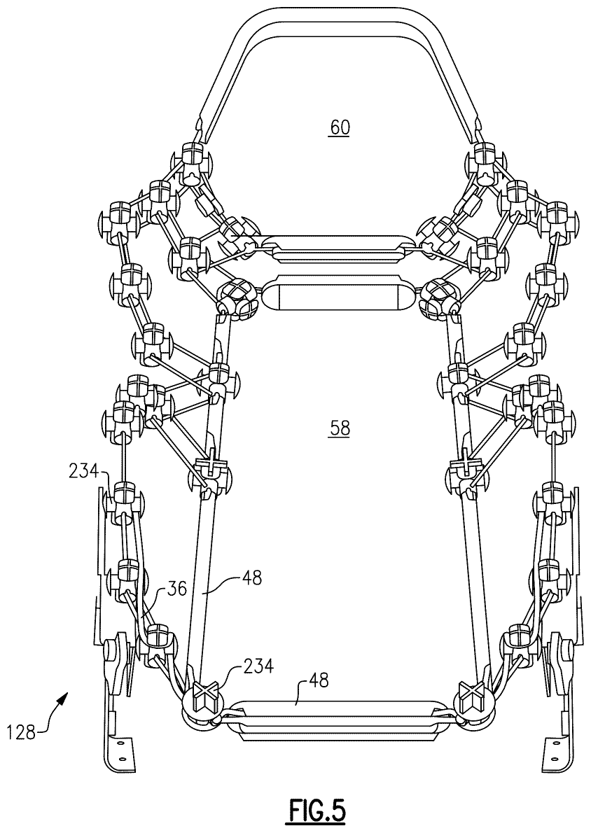

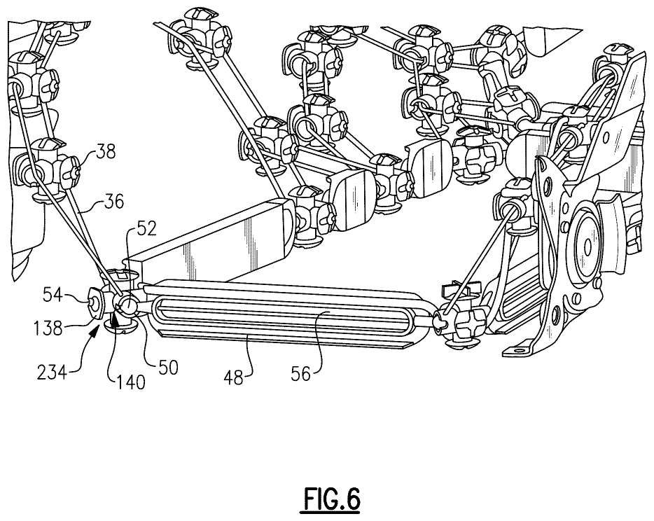

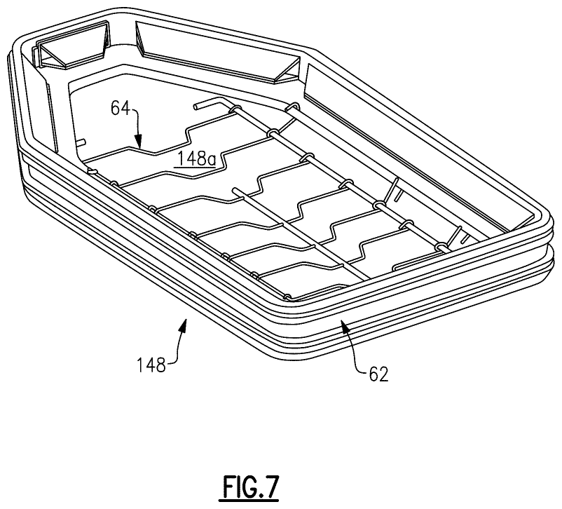

FIG. 5 illustrates another example frame 128. The frame 128 in this example includes nodes 234 and bar linkages 48 that join at least a portion of the nodes 234 together. In general, the bar linkages 48 provide additional strength and stiffness to the seat frame 128. Referring to FIG. 6, the nodes 234 each have a node body 140 and spindle portions 138 that extend form the node body 140 and that include the couplings 38. In this example, the nodes 234 have four spindle portions 138 on each node body 140 that are distributed at 90°intervals around the body 140. The adjacent sides of the body 140 include sockets 50 that connect with balls 52 on the bar linkages 48 to form ball joints. The spindle portions 138 include slots 54 for receiving and guiding the fiber bundles 36.

The balls 52 extend from the ends of the bar linkages 48. The body portion of the bar linkage 48 includes slots 56 along which the fiber bundle 36 extends between the nodes 234 at the ends of the bar linkage 48. In the example shown in FIG. 5, the bar linkages 48 are joined with nodes 234 and generally bound a seat back portion 58 and a head rest portion 60.

In the examples above, the bar linkages 48 are discrete pieces that are mechanically connected together. In another example shown in FIG. 7, rather than discrete pieces, the pieces are integrated into a single ring bar linkage 148 to provide additional stiffness. The ring bar linkage 148 circumscribes a central, open region 148a. The sides of the ring linkage 148 have outwardly-facing grooves 62 along which the fiber bundle 36 wraps around the ring. The grooves 62 are sized to contain fiber buildup. In this example, the ring linkage 148 includes a hanger 64 mounted in the interior region 148a of the ring. The hanger 64 serves as a support for other hardware in the seat and may be excluded if additional mounting is not desired.

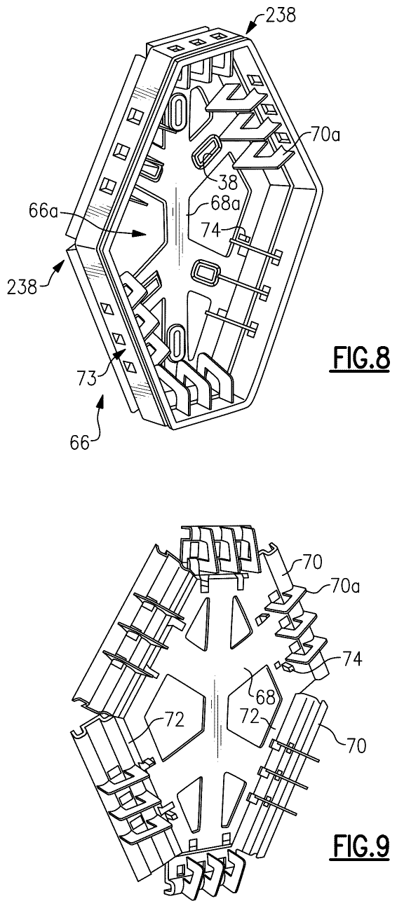

FIG. 8 illustrates another example in which the nodes 238 are on a folded substrate 66 that carries the fiber bundles 36 (not shown). The term “folded” refers to a section or sections that are bendable about an axis between two positions. In FIG. 8, the substrate 66 is in its folded state. FIG. 7 shows the substrate 66 prior to folding, i.e., in an unfolded state. Referring to FIG. 7, the folded substrate 66 includes a base portion 68, which is a central, flat section of the substrate 66. There are rails 70 connected to the base portion 68 by living hinges 72. The rails 70 are the perimeter side walls of the substrate 66. A living hinge is a thin, flexible web of material made from the same material as the rails 70 and base portion 68 that pivotably attaches the rails 70 to the base portion 68 such that the rails 70 are moveable between an unfolded, prone position (FIG. 9) and a folded, upright position (FIG. 8) relative to the base portion 68. Once folded, the substrate 66 is a ring that circumscribes an interior region 66a. The base portion 68 may have one or more ribs 68a that span across the interior region 66a to increase strength and stiffness.

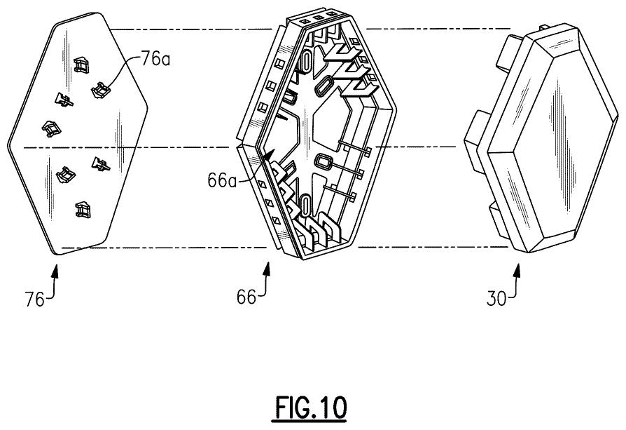

The rails 70 include outwardly-facing grooves 73 along which the fiber bundle 36 runs (not shown). The grooves 73 are sized to contain fiber buildup. Each of the rails 70 includes one or more upstanding ribs 70a. When the rails 70 are folded, the ribs 70a come to bear against the base portion 68 to act as a stop against further folding and reinforce the rail walls. The base portion 68 includes latches 74 that secure the rails 70 in the folded, upright position. For example, the latches are tabs that mechanically engage the ribs 70a to lock the ribs 70a to the base portion 68. The couplings 38 are formed in the base portion 68. In prior examples with bobbin style nodes, the nodes were discrete pieces around which the fiber bundle 36 wraps. In this example, the nodes are locations around which the fiber bundle 36 wraps to change direction. For instance, the edges where the rails 70 meet each other form nodes at which the fiber bundle 36 turns when wrapped around the substrate 66. As shown in FIG. 10, the substrate 66 is brought together with a backing plate 76 that has tabs 76a that engage the couplings 38. The cushion 30 fits into the interior region 66a and may snap into attachment features on the rails 70.

The substrate 66 is formed from a plastic material and may be injection molded, from polypropylene, polyamide, or acrylonitrile butadiene styrene, for example. The folding permits the substrate to be molded in a relatively flat geometry that does not require expensive tooling in comparison to a tool that would be required to mold the substrate with already upright rails.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A seat system comprising:
a seat frame comprising a plurality of nodes and at least one resin-impregnated fiber bundle that is wound around the nodes, the plurality of nodes comprising a plurality of couplings; and
a cushion material secured on the seat frame by the plurality of couplings.

2. The seat system as recited in claim 1, wherein the plurality of nodes are on a folded substrate.

3. The seat system as recited in claim 2, wherein the folded substrate comprises a base, rails, and living hinges pivotably attaching the rails to the base such that the rails are moveable between an unfolded, prone position and a folded, upright position relative to the base.

4. The seat system as recited in claim 3, wherein the folded substrate is a ring.

5. The seat system as recited in claim 4, wherein the rails comprise outwardly-facing grooves and the at least one resin-impregnated fiber bundle runs in the grooves.

6. The seat system as recited in claim 3, wherein each of the rails comprises at least one rib that acts as a stop when the rail is folded.

7. The seat system as recited in claim 3, wherein the base comprises latches that secure the rails in the folded, upright position.

8. The seat system as recited in claim 2, wherein couplings are in the folded substrate.

9. The seat system as recited in claim 1, wherein the plurality of nodes are on bobbins.

10. The seat system as recited in claim 9, further comprising bar linkages that join at least a portion of the bobbins together.

11. The seat system as recited in claim 10, wherein the bar linkages are coupled in ball joints to the bobbins.

12. The seat system as recited in claim 9, wherein the bobbins include slots through which the at least one resin-impregnated fiber bundle extends.

13. The seat system as recited in claim 9, wherein couplings are in the bobbins.

14. The seat system as recited in claim 1, wherein at least one resin-impregnated fiber bundle is a single resin-impregnated fiber bundle that is wrapped continuously around the nodes.

15. A seat system comprising:
a seat bottom;
a seat back that is adjustable relative the seat bottom, the seat back including a seat frame comprising a plurality of bobbins defining nodes and at least one resin-impregnated fiber bundle that is wound around the nodes, the plurality of nodes comprising a plurality of couplings; and
a cushion material secured on the seat frame by the plurality of couplings.

16. The seat system as recited in claim 15, further comprising bar linkages that join at least a portion of the bobbins together.

17. The seat system as recited in claim 16, wherein the bar linkages are coupled in ball joints to the bobbins.

18. The seat system as recited in claim 15, wherein the bobbins include slots through which the at least one resin-impregnated fiber bundle extends.

19. A seat system comprising:
a seat bottom;
a seat back that is adjustable relative the seat bottom, the seat back including a seat frame comprising a folded substrate defining nodes and at least one resin-impregnated fiber bundle that is wound around the nodes, the plurality of nodes comprising a plurality of couplings; and
a cushion material secured on the seat frame by the plurality of couplings.

20. The seat system as recited in claim 19, wherein the folded substrate comprises a base, rails, and living hinges pivotably attaching the rails to the base such that the rails are moveable between an unfolded, prone position and a folded, upright position relative to the base.
